(19) United States
(12) Patent Application Publication
(10) Pub. No.: US 2023/0244715 A1
(43) Pub. Date: Aug. 3, 2023

(54) SYSTEMS AND METHODS FOR MATCHING LISTENERS AND ARTISTS

(71) Applicant: MuzicSwipe LLC, Miami, FL (US)

(72) Inventors: Jackie Dalius, Miami Beach, FL (US); Eric Dalius, Miami Beach, FL (US); Brad Dalius, Miami Beach, FL (US)

(21) Appl. No.: 18/104,110

(22) Filed: Jan. 31, 2023

Related U.S. Application Data
(60) Provisional application No. 63/305,217, filed on Jan. 31, 2022.
(60) Provisional application No. 63/319,756, filed on Mar. 14, 2022.
(60) Provisional application No. 63/331,246, filed on Apr. 14, 2022.

(51) Int. Cl. G06F 16/635; G06F 16/638

(52) U.S. Cl. CPC G06F 16/637; G06F 16/639

(57) ABSTRACT

A computer-implemented method for matching users to artists including receiving an audio file from an artist and a selection of a first song clip. The method includes receiving a visual content file associated with the first song clip from the artist and storing the song clip in a song clip database including a plurality of song clips associated with a plurality of artists. The method includes causing the first song clip to be played on a user computing device associated with a user, wherein the first song clip is played via a user interface. The method include receiving a like indication from the user via the UI while the first song clip is playing, and determining a song queue based at least partially on receiving the like indication from the user, wherein the song queue includes one or more of the plurality of song clips.

### CROSS-SECTION TO RELATED APPLICATIONS

This application claims priority to U.S. Provisional Application No. 63/305,217, filed Jan. 31, 2022, U.S. Provisional Application No. 63/319,756, filed Mar. 14, 2022, and U.S. Provisional Application No. 63/331,246, filed Apr. 14, 2022, the disclosures of which are incorporated by reference herein in their entirety.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Traditionally, fans of music and other audio or visual media may have difficult experiences finding new artists that they appreciate amongst the vast swath of artists to choose from. A system is needed to help users identify new artists based on their own preferences in order to increase the likelihood of discovery and improve user experience.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a computer-implemented method for matching users to artists. The method may include receiving one or more audio files from an artist computing device and receiving a selection of a first song clip from the artist computing device. The first song clip may be a portion of a first audio file of the one or more audio files and may be associated with a first artist. The method may include receiving a visual content file associated with the first song clip from the artist computing device and storing the first song clip in a song clip database including a plurality of song clips associated with a plurality of artists. The method may include causing the first song clip to be played on a user computing device associated with a user, wherein the first song clip may be played via a user interface (UI). The method may include receiving a like indication from the user via the UI while the first song clip is playing and determining a song queue based at least partially on receiving the like indication from the user. The song queue may include one or more of the plurality of song clips.

In another embodiment, the disclosure describes a computer-implemented method of matching artists to users that may include receiving at least one song clip associated with each of a plurality of artists via an artist computing device associated with each of the plurality of artists. The method may include aggregating the plurality of song clips into a song clip database and determining a song queue for a user based on one or more user preferences associated with the user. The song queue may include a subset of the plurality of song clips in the song clip database. The method may include causing the song queue to play on a user computing device associated with a user via a user interface (UI), and receiving a like indication from the user via the UI while at least one song clip from the song queue is playing. The method may include providing a match indication via the UI when a number of like indications associated with song clips associated with a particular artist has exceeded a threshold.

In another embodiment, the disclosure describes a computer-implemented method of matching an artist to users. The method may include receiving an audio file from a plurality of artist computing devices each associated with an artist and receiving a selection of a song clip from each respective artist computing device of the plurality of artist computing devices. Each song clip may be a portion of the audio file received from each respective artist computing device. The method may include receiving a visual content file from each respective artist computing device of the plurality of artist computing devices. Each visual content file may be associated with each respective song clip selected from the artist computing device. The method may include aggregating the song clips and respective visual content files in a song clip database, and determining a song queue including a subset of the song clips in the song clip database. The method may include causing the song queue to play on a user computing device associated with a user via a user interface (UI), and receiving one or more like indications from the user via the UI while the song clips are playing. The method may include determining whether a number of like indications associated with a particular artist has exceeded a threshold and providing a match indication via the UI when the number of like indications associated with the particular artist has exceeded the threshold.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a high level diagram of an embodiment of a computer environment for a matching system as shown and described herein;

FIG. 2 is a flow chart showing an embodiment of creating a song clip using the matching system of FIG. 1

FIG. 3 is a flow chart showing an embodiment of matching a user to an artist using the matching system of FIG. 1;

FIG. 4 is a flow chart showing an embodiment of creating a non-fungible token using the matching system of FIG. 1;

FIG. 5 is a flow chart showing an embodiment of using a clip interaction processing algorithm with the matching system of FIG. 1;

FIG. 6 is a flow chart showing an embodiment of a recommendations algorithm of the matching system of FIG. 1;

FIG. 7 is a flow chart showing another embodiment of a recommendations algorithm of the matching system of FIG. 1;

FIG. 8A is a screenshot of an embodiment of a graphical user interface (GUI) of the matching system of FIG. 1;

FIG. 8B is another screenshot of an embodiment of the GUI of FIG. 8A;

FIG. 8C is another screenshot of an embodiment of the GUI of FIG. 8A;

FIG. 8D is another screenshot of an embodiment of the GUI of FIG. 8A;

FIG. 8E is another screenshot of an embodiment of the GUI of FIG. 8A;

FIG. 9 is a schematic illustration of elements of an embodiment of an example computing device that may be used in the matching system of FIG. 1;

FIG. 10 is a schematic illustration of elements of an embodiment of a server type computing device that may be used in the matching system of FIG. 1;

FIG. 11 is a flow chart of an embodiment of a method of instant matching using the matching system of FIG. 1;

FIG. 12 is a flow chart of an embodiment of a method of using an artist pass flow according to the matching system of FIG. 1;

FIG. 13A is another screenshot of an embodiment of the GUI of FIG. 8A;

FIG. 13B is another screenshot of an embodiment of the GUI of FIG. 8A;

FIG. 13C is another screenshot of an embodiment of the GUI of FIG. 8A;

FIG. 13D is another screenshot of an embodiment of the GUI of FIG. 8A;

FIG. 14 is a flow chart of an embodiment of determining artist recommendations using the matching system of FIG. 1;

FIG. 15 is an example logic for spacing out recommended song clips using the matching system of FIG. 1; and

FIG. 16 is a diagram illustrating an embodiment of a method for constructing a top trending artists list using the matching system of FIG. 1.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

In some embodiments, the disclosure describes a system for matching musical or other artists with users, listeners, fans, or other entities via a computer-implemented application. In some embodiments, the matching system may also be an artistic content and discovery platform that may help optimize artist discovery and fan or other user engagement. In some embodiments, the matching system may include an application that may run or otherwise be accessible via a user interface on a user computing device, such as a smart phone, tablet, laptop, etc. The application may provide a user with a software environment to discover musicians' or other artists' work by hearing, watching, viewing, or otherwise experiencing a sample portion or full portion of a work. In some embodiments, the application may be configured to receive inputs from the user indicating whether the user likes or does not like the portion of the artist's work presented by the application. The application may receive such user input and other similar inputs for other samples and use that user input as one of various parameters used for determining additional portions of artists' work to present to the user via the application.

In one non-limiting example of the matching system, a matching application may be configured to present a user with song clips from various artists one at a time. Some song clips may include video or other visual accompaniment, while some may be audio only, video only, still photos, etc. The application may be configured to receive an input from the user to indicate the user's opinion of a media clip, such as whether the user likes or dislikes a song and/or video clip presented. In some embodiments, the user may be prompted or otherwise allowed to “swipe” on their device left, right, up, down, etc., to indicate their preferences. For example, in some embodiments, a swipe to the left may indicate that the user does not like the media clip playing or that has played, and a swipe to the right may indicate that the user does like the song or media clip or would like to hear and/or see more media from that artist or media in a similar genre or style. Of course, those skilled in the art will recognize that different types of inputs may be used (e.g., clicking, typing, tapping, swiping, shaking or otherwise moving the user computing device, etc.) to indicate preferences for or against a particular clip. In some embodiments, the user computing device may include sensors (e.g., cameras, microphones, LiDAR, other light and sound sensors, etc.) that the application or other software may be used to recognize user facial expressions, gestures, other movements, voice inputs, or other inputs to indicate approval or disapproval of a given song clip or other media sample (e.g., thumbs up/down, smile/frown, nod/head shake, spoken “yes” or “no,” etc.).

In some embodiments, the matching application and/or matching system may receive the user input and use it as a data point to determine the next song clip to play for the user, or an entire queue of song or other media clips to play in a particular order as selected from a media database. In some embodiments, when a user has indicated a “like” input to a particular artist's media a predetermined number of times (e.g., three times, five times, etc.), the matching application may indicate that the user and the artist have “matched,” which may trigger additional options or outcomes. For example, the matching application may provide information regarding how many other users have matched with that artist, provide access to artist-specific forums, virtual chat rooms, artist information, artist songs or other media, access to real-life events with or relating to the matched artist, etc. In some embodiments, an artist match may trigger the generation of a non-fungible token (NFT) or other digital certificate that may allow a user to prove that the artist match was made. In some embodiments, the digital certificate may provide the matching user special access to live or virtual events, ticket sales, album releases, newsletters, music or video content, etc. In some embodiments, a user may trigger an instant match, which may bypass the need for a user to match with a particular artist the predetermined number of times prior to triggering an artist match. In some embodiments, the instant match may include request for or approval of a payment from the user or include some other additional action by the user.

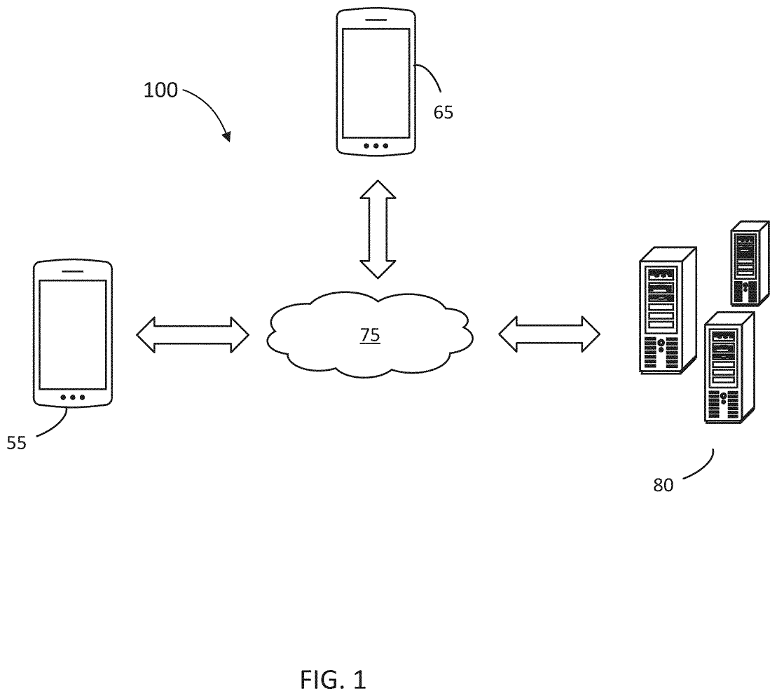

FIG. 1 shows a high level diagram of an embodiment of a computing environment 100 in which the matching system may be provided or operate. The computing environment 100 may include one or more user devices 55 that may be configured to run or otherwise host an instantiation of a matching application. The user device 55 may be configured to access one or more digital communications networks 75, such as the Internet or other local or wide area networks. A matching server 80 may also be configured to access the digital communications network 75 such that the matching server 80 may digitally communicate with the one or more user devices 55 via the digital communications network.

In some embodiments, the matching application may be installed and configured to execute directly from the user computing device 55. In other embodiments, the matching application may be hosted remotely, such as on the matching server 80, and may be accessed by the user device 55 via the digital communications network 75. In such embodiments, the user device 55 may access the matching application via software or user interfaces on the user device, such as a web browser. In some embodiments, the matching application may be stored and/or hosted on the user device 55 but may communicate with the matching server 80 to perform particular tasks relevant to the matching application's functionality. In some embodiments, the matching sever 80 may include one or more databases for storing user profile information, storing song and/or video files or clips, storing artist information, etc. In some embodiments, the matching application may access audio/video files stored on the matching server and stream the audio and/or video to the user device 55 for the user to hear/see. In some embodiments, all or some song/video clips may be stored on the user device 55, or may be downloaded and played for the user at a later time. For example, in some embodiments, the matching application may construct a queue of song clips and download those queued clips to the user device 55 prior to playing them on the user device, and may delete those clips once they have played and the user has provided feedback. Of course, in some embodiments, all or some of the logic performed in determining which song clips to play for a particular user may be performed on the user device 55 or on the matching server 80.

The computing environment 100 may also include one or more artist computing devices 65 that may also have access to the digital communications network 75. The artist computing devices may be any suitable computing device, such as a smart phone, tablet, laptop, etc. The matching server 80 may be configured for artists to access their own artist profiles via an artist computing device 65, which may allow such artists to upload video/song clips, access and/or edit an artist profile, check statistics related to the artist such as number of matching users, number of views/listens, etc. In some embodiments, certain features of the matching application may be accessed or processed via one or more application programming interfaces (API). For example, in some embodiments, an artist computing device 65 may use a matching API to upload video and/or audio files of song/video clips of that artist's works for users to experience through the matching application via a user computing device 55.

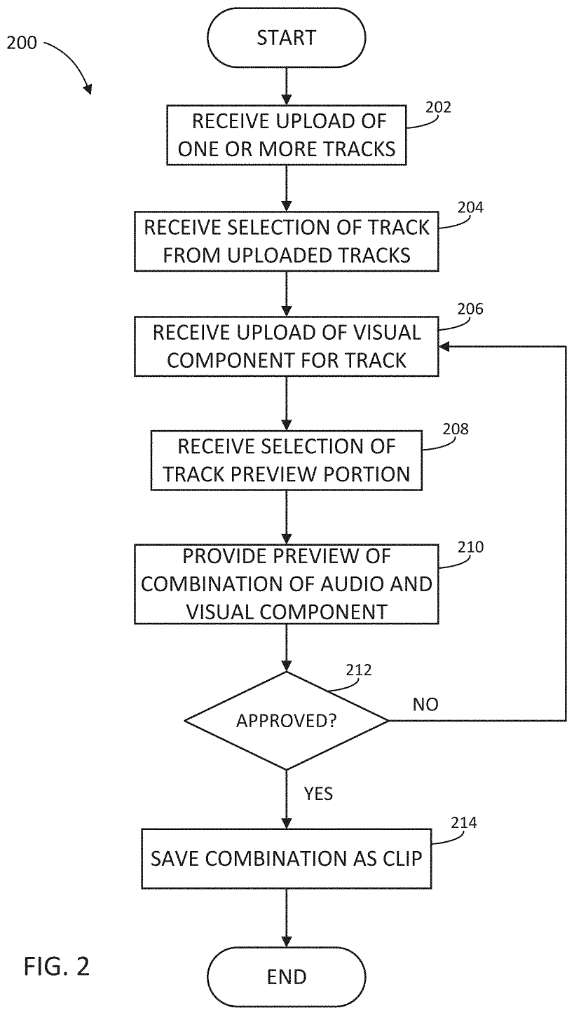

FIG. 2 is a flow chart illustrating an embodiment of a method 200 for creating a clip for use by some embodiments of the matching application. In some embodiments, the method 200 may occur as communication or transfer of data between one or more artist devices, such as the artist device 65, and the matching server 80. The method may include, at 202, receiving an upload of a one or more tracks or media files, such as from the artist device 65 to the matching server 80 via the digital communications network 75 or to another cloud storage system (e.g., Amazon Web Services, etc.), wherein the one or more tracks may be digital music files, digital video files, etc. At 204, the method may include receiving a selection, such as from an artist computing device, of a track from the one or more uploaded tracks or other stored media files. In some embodiments, the method may include, at 206, receiving one or more uploads of a visual media component to accompany the selected track, such as a digital photograph file, digital video file, etc, such as from the artist computing device. The method 200 may include, at 208, receiving a selection of a track preview portion or segment of the selected track or other media, such as a 15 second clip, 30 second clip, or some other length. The selection of the track preview portion may occur via a graphical user interface (GUI) of the matching application, such as with visual sliders, buttons, track time inputs or other selections, etc. In some embodiments, the method may include receiving, such as from the artist computing device, a selection of a genre, such as a musical or other media genre, that may be associated with the selected track and/or clip. In some embodiments, the matching application running on an artist computing device may provide a list of genres to select from via a pulldown menu or other selection means.

The method 200 may include, at 210, providing a preview of a combination of the uploaded visual component and the selected track segment (i.e., audio content) as a clip preview. In some embodiments, the preview may be provided via the matching application on the artist computing device. If, at 212, the artist/user does not approve the clip preview, the artist may, at 206, select or upload a different visual component and/or select a different track segment, at 208, to use as the audio content of the clip. If, at 212, the artist approves of the clip preview on the first or subsequent attempts, the method may, at 214, include receiving an approval or save input from the artist via the artist computing device and saving the clip in the matching system, such as in a database and/or on the matching server 80. In some embodiments, the method may include providing an option for and receiving an artist selection to “boost” a song clip, which may give the song clip priority over other non-boosted song clips, as described in more detail below.

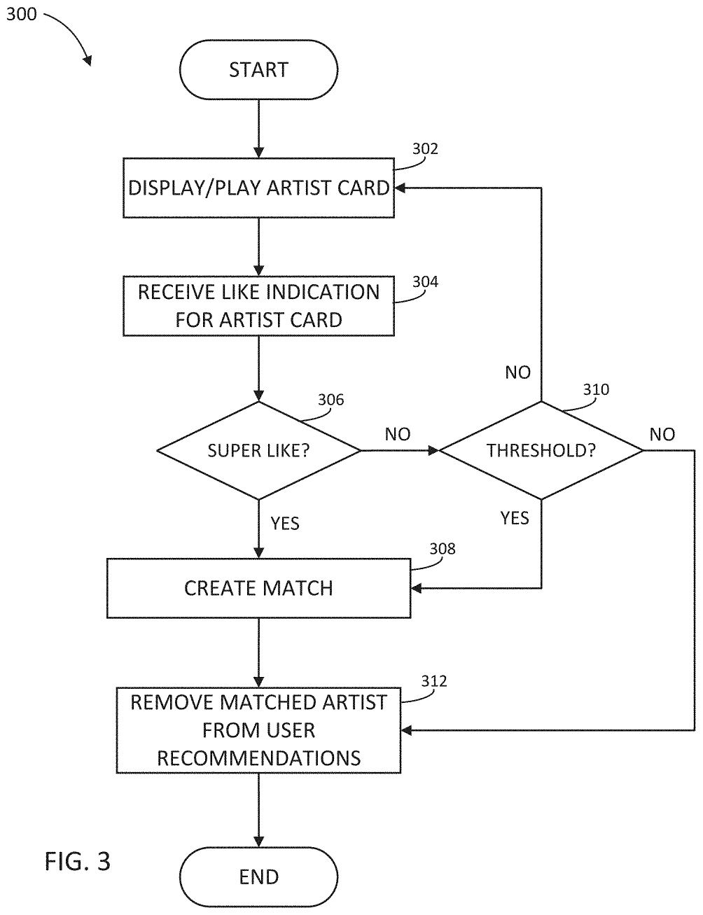

FIG. 3 is a flow chart illustrating an embodiment of a method 300 for matching an artist to a user using an embodiment of the matching application. In some embodiments, during operation of the matching application, at 302, a user may be sequentially shown/played “cards” of various artists, where the cards may be a song clip or other media uploaded by artists and stored on a song clip database (e.g., at matching server 80). In some embodiments, the matching application may display information about the artist while or after the card plays, or may not show artist information in other embodiments such that the user may not know who the artist is. The matching application may show and/or play the card via the user computing device's display and may play audio via the user computing device 55 speakers, headphones, remote speakers, etc. The method 300 may include presenting a first artist card and, at 304, receiving a “like” or “don't like” indication from the user via the user device 55. In some embodiments, the like or approval indication may include the user swiping across the user device's display screen to the right, but other forms of approval may also be used. In some embodiments, when the matching application receives a like or approval indication from a user relating to the first artist card, the matching application may, at 306, determine whether the like indication was a “super like.” A “super like” may be indicated in one of a variety of non-limiting ways, such as tapping the device, tapping a real or virtual button on the user device, speaking into the device's microphone, shaking the device, making a gesture, etc. If a super like has been indicated, the method may include, at 308, creating a “match” between the user and the artist associated with the first artist card. In some embodiments, the method may include determining whether the user has any super likes available in their profile, such as by having previously purchased them for use or by otherwise earning one or more super like uses. If a super like is available and his been indicated at 306, then a match may be created at 308. If the user has not indicated a super like or if the user has no super likes available, the method 300 may, at 310, include determining whether the user has liked a predetermined threshold number of artist cards from the particular artist associated with the first artist card. In some embodiments, the predetermined threshold number of liked cards may be three, but may be other numbers in other embodiments. If the predetermined threshold number has been met, the method may include, at 308, creating a “match” between the user and the artist associated with the artist card. In some embodiments, at 312, the method may then include removing the matched artist from the user's recommendations, which may include refraining from playing subsequent artist cards associated with the matched artist. In other words, once the artist match has been made, the user may be provided with the artist information and may no longer have a need to “discover” this artist. In some embodiments, if the predetermined threshold number has not been met at 310, the method may include displaying and/or playing additional artists cards at 302.

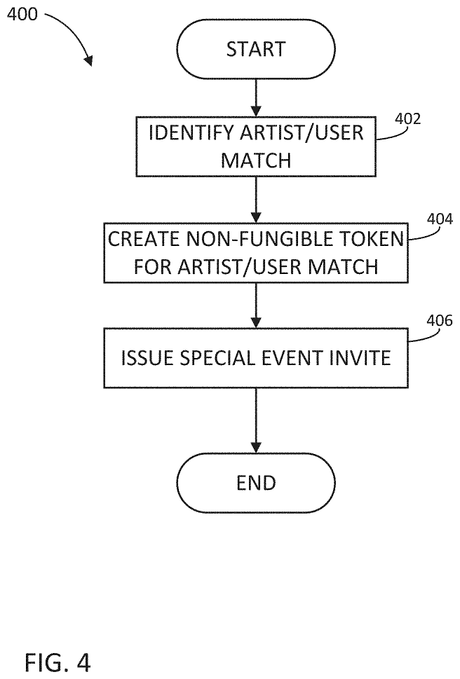

FIG. 4 is a flow chart illustrating an embodiment of a method 400 for converting a “match” with an artist into a non-fungible token (NFT) or other unique digital certificate. In some embodiments, once a match is established between a user and an artist using the matching application, such as described above with reference to FIG. 3, the matching application may generate an NFT thereby making the match unique and owned by the user/fan. In some embodiments, the NFT may be generated in a variety of suitable ways so as to provide the user with a digital file that may be used as proof of ownership of a particular match. In some embodiments, the NFT may be minted and stored on one of a variety of blockchains accessible to the public so that a user may indicate their ownership of the particular NFT, or may be minted on a private matching application blockchain. In some embodiments, the user may be able to use the NFT in order to access certain exclusive activities that may only be available to other users that have matched to a particular artist, or to, for example, the first 10, 20, 50, or 100 users who have matched. In some embodiments, the exclusive activities may include meeting the artist at a real life or virtual event, getting priority access to concert tickets, memorabilia, music releases, videos, etc. Accordingly, the method 400 may include, at 402, identifying an artist/user match in one of a variety of ways including the method 300 described with reference to FIG. 3. At 404, the method may include creating an NFT for the artist/user match, such as via the Ethereum or other suitable blockchain. At 406, the method may include issuing a special event invite for which the user may show proof of ownership of the NFT in order to access the event, which may be virtual, live, or simply provide special or early access to the artist's media.

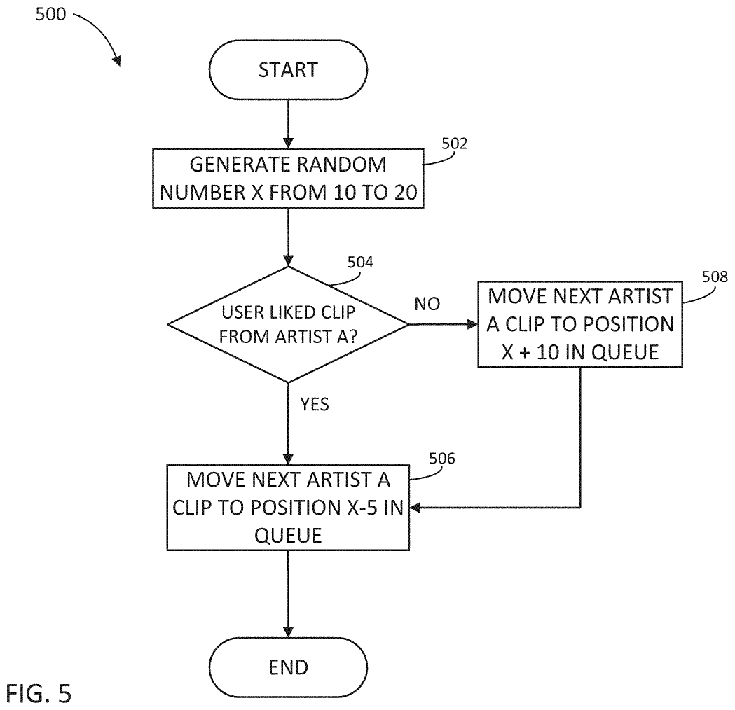

FIG. 5 is a flow chart illustrating an embodiment of a method 500 of using the matching system to provide a song clip recommendation using an embodiment of a clip interaction processing algorithm. The method 500 may include, at 502, generating a random or pseudo-random number X, such as between 10 and 20, for example. It is contemplated that, in some embodiments, X may be a predetermined number, or maybe a number determined based on other factors relating to the user (e.g., age, preferred genre, other artist preferences, etc.). If, at 504, the user has indicated they like a clip in their clip queue, such as a first clip associated with a first artist, the method may include, at 506, putting a second clip associated with the first artist in the user's queue at a position that is less than the random number X, such as X−5. If, at 504, the user indicates that the user does not like the first clip associated with the first artist, the method may include, at 508, putting a second clip associated with the first artist at a queue position larger than the random number X, such as X+10. In other words, in some embodiments, when a user indicates, such as by swiping on the user computing device, that they like a first clip from a particular artist (e.g., first artist), the clip interaction processing algorithm may move other clips from that artist earlier in the queue so that the user may be shown/played more clips from the same artist, and vice versa if the user does not like the artist clip. As the process iterates onward, the clip interacting processing algorithm may result in clips of artists that the user has liked being shown more frequently than artists the user has indicated that they do not like.

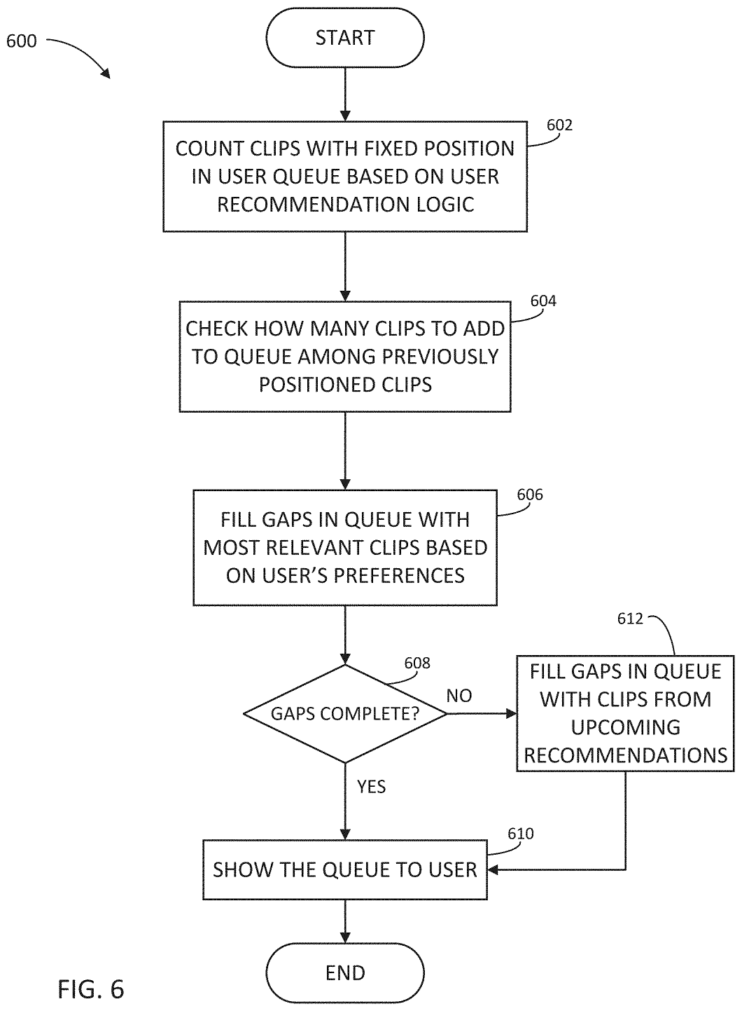

FIG. 6 is a flow chart illustrating another embodiment of a method 600 of using the matching system to provide a song or other media clip recommendation, such as by using a recommendation algorithm. The method 600 may include, at 602 determining, such as by counting, how many clips may have a fixed position in the song queue according to the user's recommendation interaction logic. At 604, the method may also include checking how many clips may be needed to be added to the queue among the previously positioned song clips in the queue. For example, the song queue may include 10 positions but only have 7 clips with fixed positions, leaving 3 gaps in the song queue. At 606, the method may include filling any gaps in the queue with the most relevant clips according to the user's musical tastes or preferences. At 608, if all the queue gaps are filled, the method may include showing the queue to the user at 610. If, at 608, all the queue gaps are not filled, the method may include, at 612, filling the queue gaps with song clips from upcoming recommendations and then showing the queue to the user at 610.

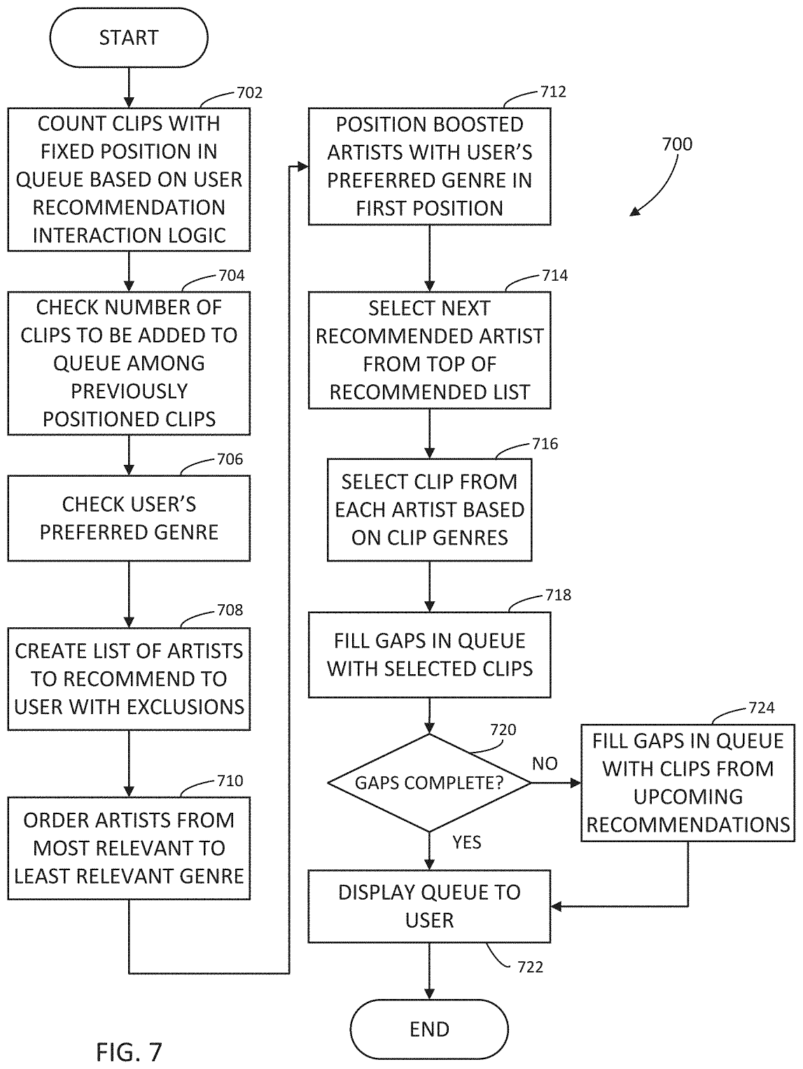

FIG. 7 is a flow chart illustrating another embodiment of a method 700 of using the matching system to construct a song clip queue to be shown/played for a user in sequential song clips with a recommendation algorithm. The method 700, at 702, may include determining, such as by counting, the number of clips that may have a fixed position in the song queue according to the user's recommendation interaction logic. The method may also include, at 704, checking how many clips may be needed to be added to the queue among the previously positioned song clips in the queue. The method may include, at 706, checking a user profile or other user data to determine what the user's current preferred genres may be. In some embodiments, this may be set by the user in a user profile or may be determined by the matching application based on observed user preferences (e.g., genres of liked songs, liked artists, etc.). In some embodiments, a user may be requested via the matching application to select one or more top genres, such as three top genres, that may be used to determine song clip recommendations. In some embodiments, the user may change these genre preferences at any time using the matching application.

At 708, the method may include creating a list of artists to recommend to the user. In some embodiments, the list of artists may exclude one or more of the matched artists for the user, artists with no clips available, and/or artists that are already placed in the recommendation pool for the user. The method may include, at 710, ordering the artists from the most relevant to the least relevant, such as based on musical genre and/or other relevant criteria. The method may include, at 712, positioning in a first position a boosted artist that may be associated with the user's preferred genre and, at 714, selecting an artist from the top of the recommendation list to recommend next (i.e., second). At 716, the method may include selecting at least one clip from each artist based on a musical genre associated with the clips and, at 718, filling any queue gaps with the selected clips. If all the queue gaps are filled, the method may include showing the queue to the user. If, at 720, all the queue gaps are filled, the method may include displaying the queue to the user at 722. If, at 720, all the queue gaps are not filled, the method may include, at 724, filling the queue gaps with song clips from upcoming recommendations and then showing the queue to the user at 722.

Those skilled in the art will recognize that the methods described herein are non-limiting methods by which a user's queue may be selected and shown to a user based on one or more user parameters, including user selected preferences such as genre, other artists, other songs, time periods, instrument types, etc. The one or more user parameters may also include location, age, gender, prior observed preferences related to musical choice, etc.

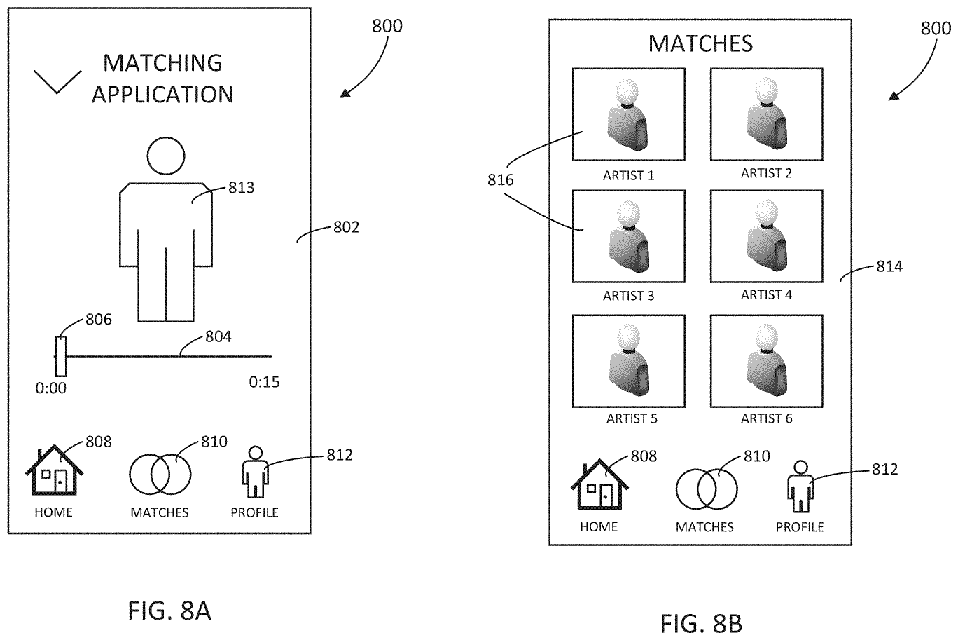

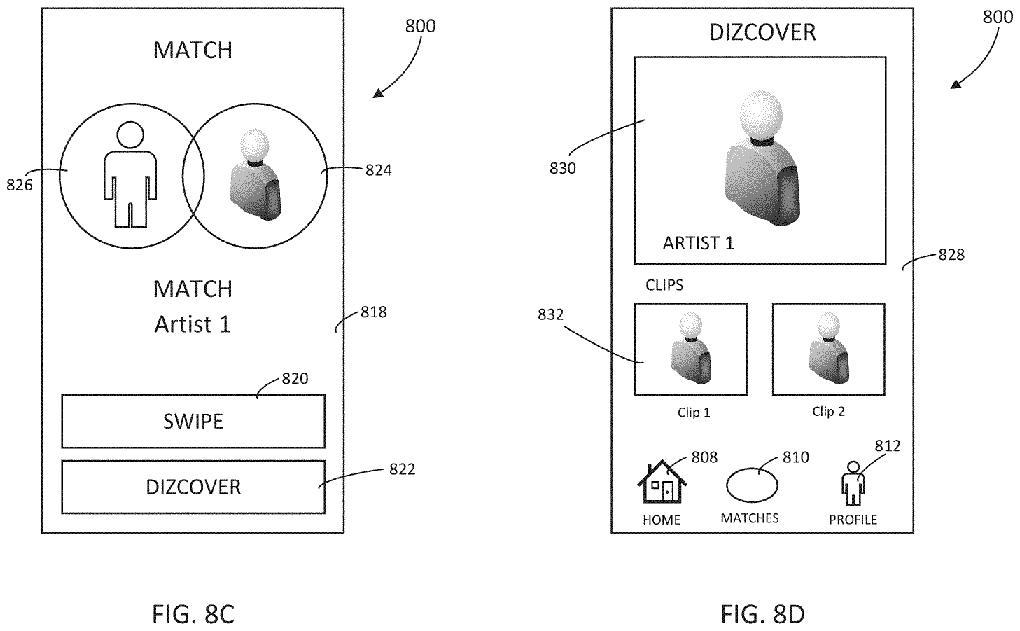

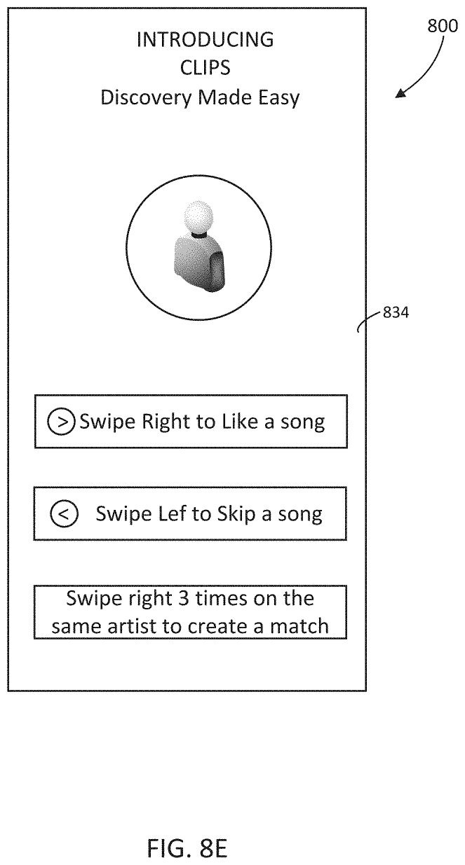

FIGS. 8A-8E show embodiments of a user interface 800 that may be used in some embodiments of the matching application of the matching system, such as while running on a user computing device or an artist computing device. In some embodiments, the user interface may be provided as part of a matching application running on a user device, or may be accessible remotely such as via a web browser running on the user device. Those skilled in the art will understand that the user interface shown in FIGS. 8A-8E may be just one possible embodiment of the user interface, and that other suitable user interfaces may be used to execute all or portions of the methods and systems described herein related to the matching system.

FIG. 8A shows a screenshot of a user interface (UI) 800 or graphical UI (GUI) playback screen 802 that may include visual content and an elapsed time indicator 804 to show how much time has elapsed and that may be remained in a current song clip being listened to or viewed by a user. During song clip playback, a progress bar 806 may indicate the current portion of the song clip, and may be moved forward or backward in some embodiments by a user to advance or rewind the song clip. In some embodiments, during the song clip playback, the user may swipe left or right, for example, on the GUI in order to indicate that the user dislikes or likes the current song clip. The GUI 800 may include one or more selectable icons, such as Home 808, Matches 810, and Profile 812 that a user may select to access different features of the matching application or the GUI itself. In some embodiments, the playback screen 802 may include visual content 813 that may have been selected by the user (e.g., photo, video clip, animation, etc.) for all that artist's clips, or for the particular song or clip, or may include a default image or other media selected by the matching application based on genre, artist, song type, random selection, etc.

FIG. 8B is a screenshot of an example matches screen 814 that may be accessed, for example, by selecting the Matches 810 icon on the GUI 800. In some embodiments, the matches screen 814 may show artist information 816, such as names, photographs, and/or other content associated with artists that the user may have “matched” with in the past through using the matching application. FIG. 8C shows a screenshot of an embodiment of a match confirmation screen 818 that the GUI 800 may show when the matching application may determine that the user has “matched” with an artist in one or more of the methods described above. In some embodiments, the match confirmation screen 818 may provide options for additional inputs for the user to access additional content or activities, such as a Dizcover button 822 to learn more about the artist or access more artist content, and/or swipe 820 to indicate, for example, that the user would like to return to hear/watch additional song clips to find additional matches. In some embodiments, the match confirmation screen 818 may show visual content 824 associated with the artist overlaid or otherwise positioned with relation to visual content 826 of the user, such as an uploaded photo or other pre-selected content. FIG. 8D shows a screenshot of an embodiment of a discover screen 828 that may, in some embodiments, be provided to or be accessible by a user that has matched with a particular artist, such as Artist 1. In some embodiments, the discover screen 828 may include information about the artist 830, such as their name, photo, or other content, and may include a clips portion 832 to provide options to select additional song clips of the artist to experience. In some embodiments, a user may be prevented from accessing a Dizcover screen 828 for a particular artist until the use has matched with that artist.

FIG. 8D shows a screenshot of an instruction screen 834 that may provide instruction to a user of the matching application regarding certain operations of the GUI 800 and/or matching application. In some embodiments, the instruction screen 834 may instruct a user to swipe right to like a song, swipe left to skip and/or dislike a song, and that a match may be made with an artist if a user swipes right a predetermined number of times, such as three times for songs associated with the same artist. Those skilled in the art will recognize that other gestures or actions may be used with similar results within the scope of the disclosure.

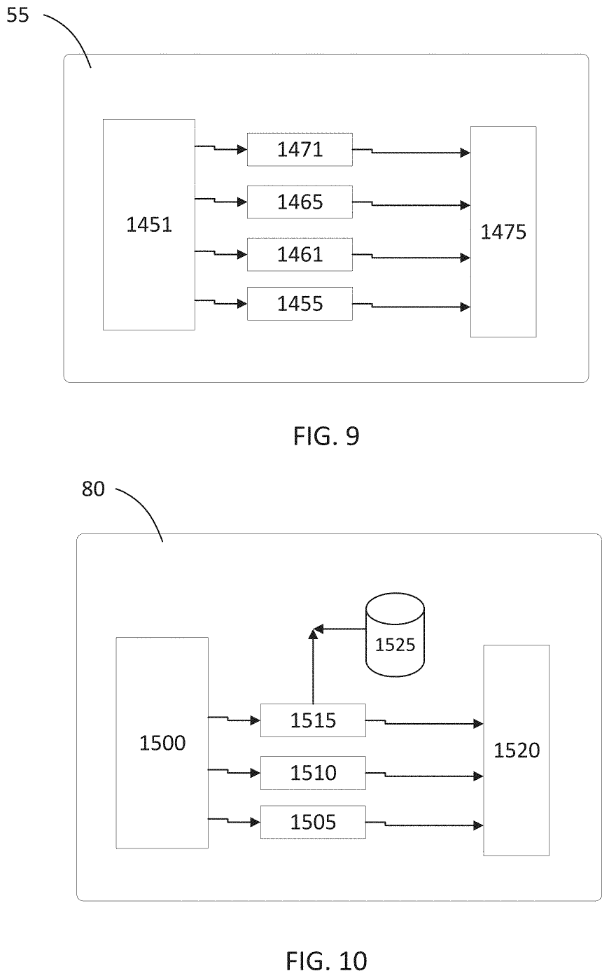

FIG. 9 is a simplified illustration of some physical elements that may make up an embodiment of a computing device, such as the user computing device 55, and FIG. 10 is a simplified illustration of the physical elements that make up an embodiment of a server type computing device, such as may be used for the matching server 80. Referring to FIG. 10, a sample computing device is illustrated that is physically configured to be part of the systems and method for an immersive audio experience. The computing device 55 may have a processor 1451 that is physically configured according to computer executable instructions. In some embodiments, the processor may be specially designed or configured to optimize communication between a server relating to the system described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera, a display, or other input/output devices. The computing device 55 also may control communicating with networks either through wireless or wired devices. Of course, this is just one embodiment of a computing device 55 and the number and types of computing devices 55 is limited only by the imagination.

The physical elements that make up an embodiment of a server, such as matching server 80, are further illustrated in FIG. 10. In some embodiments, the server 80 may be specially configured to run the system and methods for matching listeners and artists as disclosed herein. At a high level, the server may include a digital storage such as a magnetic disk, an optical disk, flash storage, non-volatile storage, etc. Structured data may be stored in the digital storage a database. More specifically, the server 80 may have a processor 1500 that is physically configured according to computer executable instructions. In some embodiments, the processor 1500 can be specially designed or configured to optimize communication between a computing device, such as computing device 55, and NV equipment or matching server 80 as described herein. The server may also have a sound and video module 1505 which assists in displaying video and sound and may turn off when not in use to conserve power and battery life. The server 80 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks either through wireless or wired devices. In some embodiments, a matching controller for running a matching API may be located on the computing device 55. However, in other embodiments, the matching controller may be located on server 80, or both the computing device 55 and the server 80. Of course, this is just one embodiment of the server 80 and additional types of servers are contemplated herein.

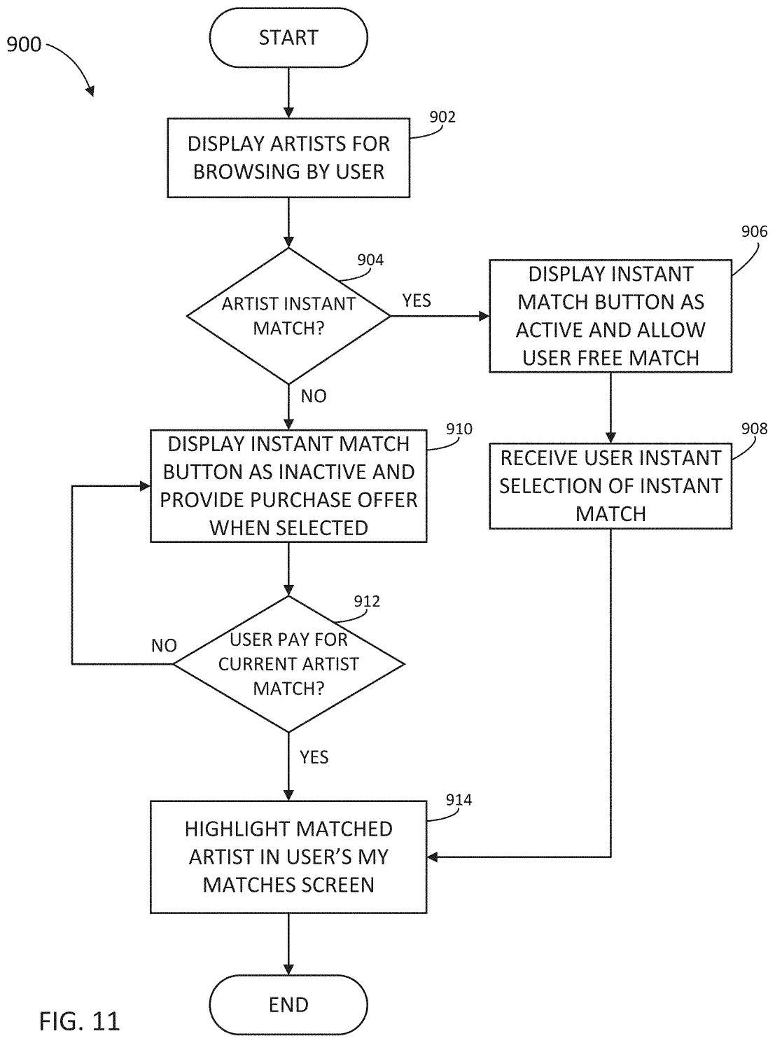

FIG. 11 is a flowchart illustrating an embodiment of a method 900 of using the matching system, particularly an “instant match” mode or functionality of the matching system. In some embodiments, instant match may enhance the user's music or artist discovery experience by providing more efficient methods for matching with the artists they enjoy. In some embodiments, the instant match functionality may be provided as an alternative to embodiments of functionalities that may require a predetermined number (e.g., 3 matches) of user/artist matches in order to provide a connection. The instant match functionality may, in some embodiments, provide users with the ability to match with an artist “instantly,” that is, without swiping to find matches. In some embodiments, the matching system may request or receive payment from a user in exchange for access to the instant match functionality, or the user may earn the instant match functionality in other ways, such as by matching with a predetermined number of other artists, or after a predetermined elapsed time period.

The method 900 may include providing the matching application for users to browse, such as via a Home screen or other GUI screens. At 902, the method may include displaying artists for browsing by a user, such as by playing artist clips or by providing other artist media for user review, such as artist information cards. At 904, the method may include determining whether an artist that a user may be browsing via the matching application has any pre-paid or otherwise pre-activated instant match capabilities assigned to them. For example, an artist may choose to make available certain numbers of instant matches so that users may more easily find and connect to them. In some embodiments, these may be provided by the matching application in exchange for a payment or other compensation. If the artist has pre-paid instant matches, at 906, an instant match button or other suitable indicator on the particular artist's home screen may be activated, such as by displaying in red or another predetermined activation color. At 908, the user may activate the instant match by selecting the instant match button. In some embodiments, the artist with which the instant match has been made may then appear in the user's “My Matches” screen, such as the My Matches screen shown and described with reference to FIG. 8B.

In some embodiments, if, at 904, the artist does not have any pre-paid or otherwise available instant matches, at 910, the artist's home screen may have a deactivated instant match button, such as by being displayed in black or some other predetermined color. In some embodiments, if a user selects the deactivated instant match button, the matching application may display a purchase screen asking the user whether they would like to purchase or otherwise activate an instant match with the current artist. In some embodiments, the purchase screen may include one or more selection options via buttons, such as “no,” “yes,” or a button listing the price of the instant match, for example. If, at 912, the user selects “no”, the matching application may return the user to the artist's home screen in some embodiments. In some embodiments, if the user selects “yes” or the price button, at 914, the user may be provided with an instant connection to the artist and charged accordingly. In some embodiments, the artist with which the instant match has been made may then appear in the user's “My Matches” screen. In some embodiments, free instant match passes may be provided to users or artists via promotional events, social media engagement, referral rewards, artists passes, etc.

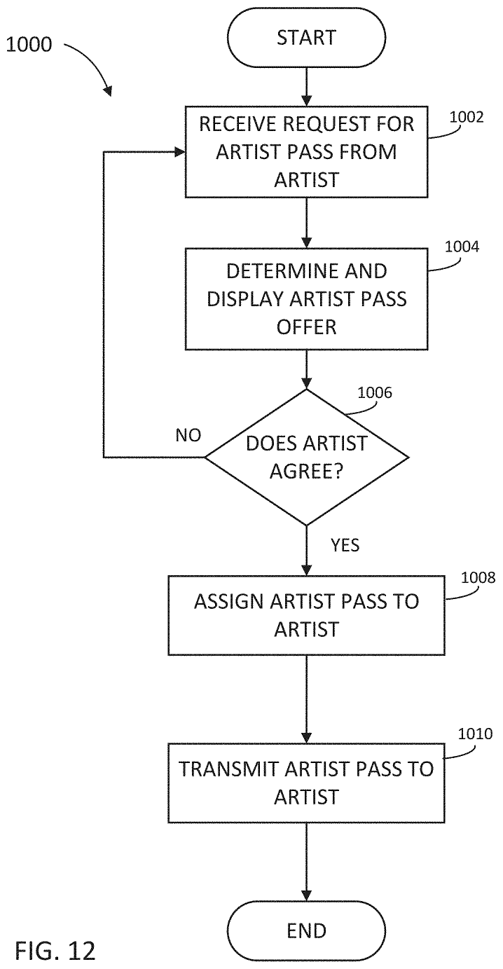

FIG. 12 is a flowchart illustrating an embodiment of a method 1000 of using the matching system, particularly in an “artist passes” mode or functionality. In some embodiments, at 1002, the system may receive from the artist who has submitted a clip or other media may request one or more Artist Passes that may provide one or more users with the ability to instant match to that artists at no additional cost or at a discount to that user. In some embodiments, the matching application may provide a screen for the artist to request Artist Passes. In some embodiments, the Artists Passes may be provided to the artist for a predetermined cost, or may be provided through promotional events or other reasons. In some embodiments, at 1004, the matching system may determine a price offer in exchange for the Artist Pass, which may be predetermined, or may be provided based on an algorithm and specific to the artist, genre, time working with the matching system, etc. If, at 1006, the artist does not agree to the offer, the Artist Pass may not be issued. If, at 1006, the artist agrees to pay that price and does so, at 1008, the matching system may automatically or manually credit the artist with the purchased Artist Passes to be provided to users in one or more ways. In some embodiments, at 1010, the artist may then use the matching application to distribute the artist passes as they wish, such as by making them available to users on the artist's home page or selectively passing them out based on other criteria.

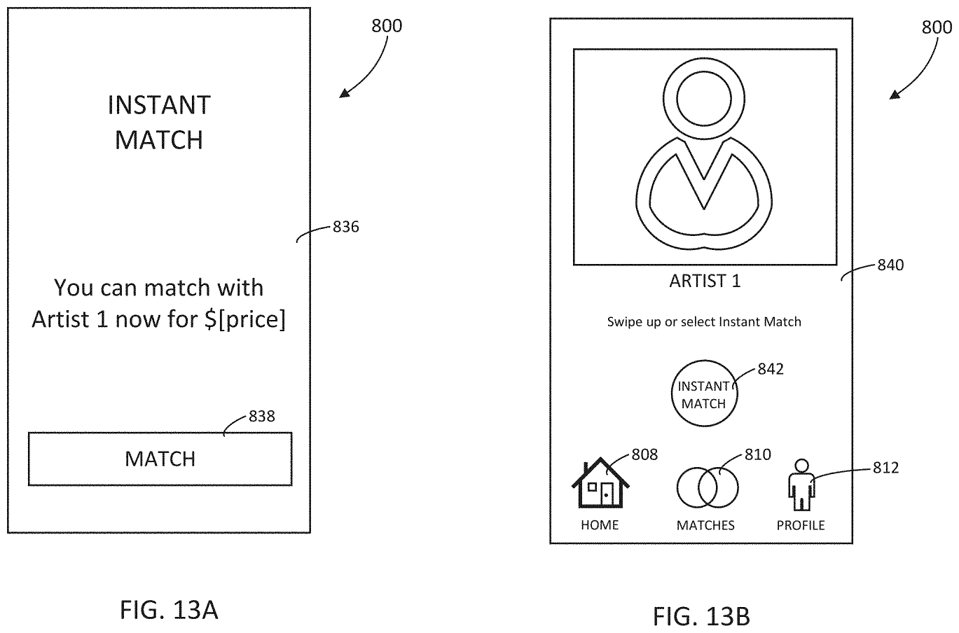

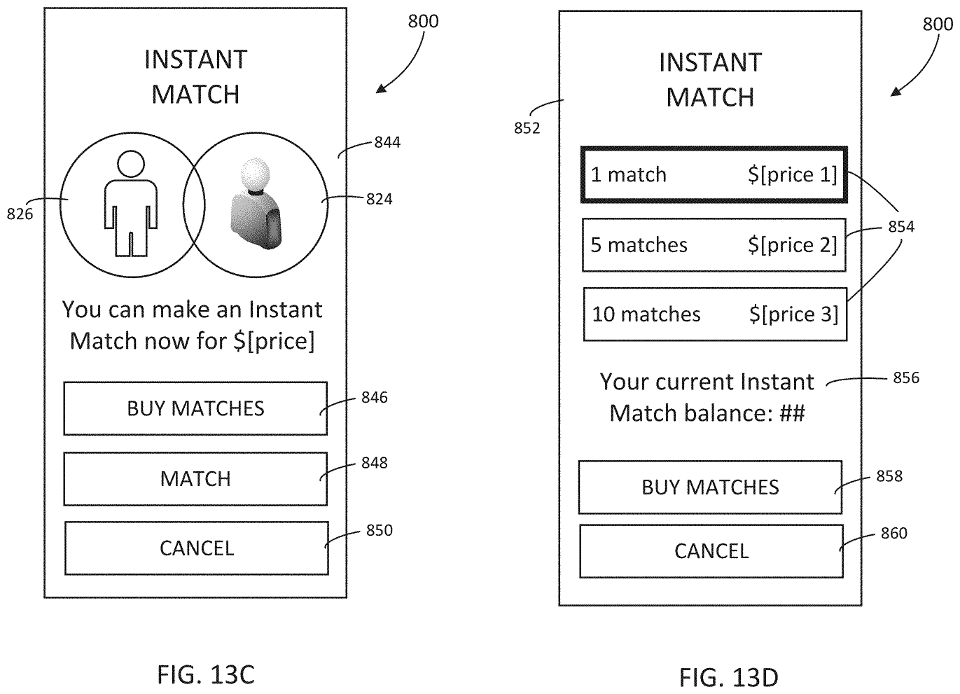

FIGS. 13A-G show embodiments of screens of a user interface 800 that may be used in some embodiments of the matching system, such as along with the user interface screens portrayed in FIGS. 8A-E. In some embodiments, the user interface 800 may be provided as part of a matching application running on a user device, or may be accessible remotely such as via a web browser running on the user device. Those skilled in the art will understand that the user interface screens shown in FIGS. 8A-E and 13A-G may be just one possible embodiment of the user interface, and that other suitable user interfaces may be used to execute all or portions of the methods and systems described herein related to the matching system.

FIG. 13A shows a screen shot of an embodiment of an instant match offer screen 836 that may be included in some embodiments of the GUI 800 of the matching application. In some embodiments, the instant match offer screen 836 may provide a user with the option of selecting a “match” button 838 in order to create an instant match with a particular artist. FIGS. 13B-G show consecutive screen shots that may be included in some embodiments of the matching application GUI 800 that may be used in an instant match flow, for example. FIG. 13B shows an embodiment of an artist home screen 840 that a user may encounter when browsing artists featured in the matching application. In some embodiments, the artist home screen 840 may be shown when the matching application may be playing a song or other media content provided by that particular artist. In some embodiments, the user may swipe left or right to express like or dislike of an artist. In some embodiments, the matching application may additionally provide for an instant match between the artist and the user, which may provide a shortcut to connecting with an artists without reaching a predetermined number of matches with that artist. When the artist has made instant matches available, or when a user has previously purchase instant matches, for example, or when an instant match may otherwise be available to a user for a particular artist, an instant match button 842 may be activated on the artist home screen 840 such that the instant match button may be selectable by the user to initiate an instant match with that artist. In some embodiments, the instant match button 842 may be indicated as active such as when it is a particular color, such as red or green, and may be deactivated when it is another color, such as black or gray.

In some embodiments, when a user selects the instant match button, the user may immediately be matched with an artist, such as when the user has previously purchased or otherwise acquired an instant match credit or when the artist had previously made instant matches available to one or more fans by purchasing them or otherwise acquiring the instant match credits. In some embodiments, when a user selects the user selects an activated instant match button 842, the matching application may display a purchase screen. FIG. 13C shows an embodiment of a purchase screen 844 that may be included in some embodiments of the GUI 800 of the matching application. The purchase screen 844 may include several options for the user to select, such as a “buy matches” button 846, a “match” button 848, or a “cancel” button 850. In some embodiments, the buy matches button 846 may be selected via the GUI 800 to allow the user or artist to purchase instant matches at the offered price, such as with the artist a user has just liked, or just additional matches. In some embodiments, the match button 848 may be selected to return to the matching queue to view more clips, and the cancel button 850 may be selected to cancel out of the purchase screen 844. FIG. 13D shows an embodiment of an instant match pass packages screen 852 that may be included in some embodiments of the GUI 800 of the matching application. In some embodiments, the instant match pass packaging screen 852 may be activated when the user selects the “buy matches” button 846 on the purchase screen 844, for example, but may be activated in other ways as well. In some embodiments, the instant match pass packages screen 844 may include options to buy “packages” 854 of one or more instant match passes that may each provide the user with the ability to instant match with artists or a select group of artists for which instant match may be available. For example, in some embodiments, instant match pass packages 854 may be offered for sale in packages of one instant match pass package, five instant match pass packages, ten instant match pass packages, etc. The instant match pass packaging screen 844 may include a buy matches button 858 that may be selected to initiate a purchase of one of the selected buy packages 854 (e.g., “1 match” shown selected in FIG. 13D). The user may also select the cancel button 860 to cancel out of the instant match pass packaging screen 844. In some embodiments, once an instant match is made, the GUI 800 may include a match confirmation screen similar to the match confirmation screen 818 shown in FIG. 8C. For example, in some embodiments, the match confirmation screen may be shown to a user by the matching application after the user has initiated an instant match with an artist. The match confirmation screen may provide selectable buttons for the user, such as a “discover” button or a “swipe” button. In some embodiments, the discover button may cause the matching application to provide information to the user about the artist with which the user has just matched, and the swipe button may cause the user application to return the user to browsing artists and clips. In some embodiments, when an instant match may be made between a user and an artist, a matches screen, similar to the matches screen 814 shown in FIG. 8B, may be included in some embodiments of the matching application. In some embodiments, the matches screen may show one or more artists with which the user has matched in the past, and may include selectable icons or other visual buttons that may allow the user explore that particular artist. In some embodiments, the artist icons may include artwork or other visual media selected representative of the artist, and may include indicators such as “new” or whether that artist was matched with an instant match or otherwise. In some embodiments, the matches screen may include an icon or other indicator that shows whether a match was made with an instant match or otherwise.

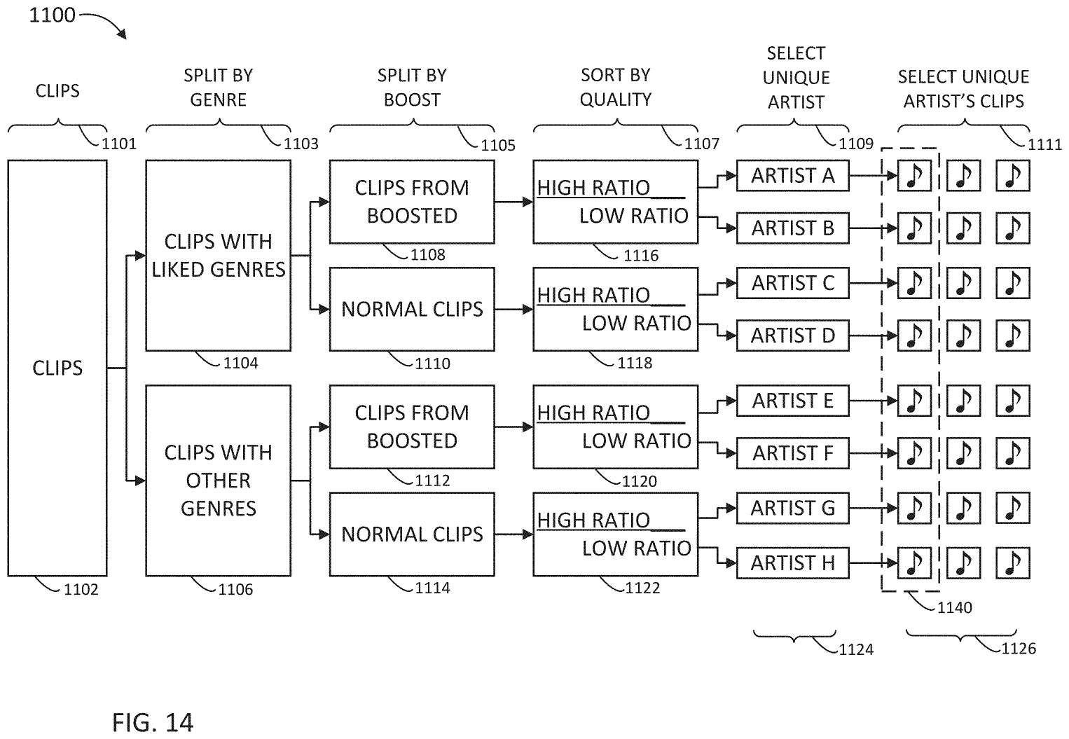

FIG. 14 shows an embodiment of a recommendations logic 1100 that may be used in some embodiments of the matching application to make song clip recommendations. In some embodiments, the recommendation logic may include breaking out user preferences based on information received directly from the user (e.g., via information input into a user profile), or determined based on prior user behavior and selections made using the matching application. In some embodiments, the matching application may split song clips into groups based on user preference rated to musical genre, whether song clips are being “boosted,” based on the quality of the song clips, based on the unique artists associated with the song clips, and the artist's clips themselves. For example, referring to FIG. 14, in some embodiments, the matching application may, at 1101, begin with a pool of clips 1102 and, at 1103, split the clips by genre, then split further by boost status 1105, then sort by quality 1107, then sort by unique artist 1109, and then each unique artist's clips 1111. In some embodiments, at 1103, the matching application may split the available pool of song clips 1102 into a liked genre group 1104 including song clips having a musical genre that that may be liked by the user (e.g., through selected profile preferences, through liking clips, etc.) and an other genre group 1106 that may include song clips having musical genres that have not been “liked” or otherwise determined to be preferred by the user. For example, if a user indicated in their user profile that they liked the country music genre and had previously liked songs in the R&B genre, the liked genre group may include clips from the pool of clips 1102 that may have a country or R&B genre. In some embodiments, the matching application may split both the liked genre group 1104 and the other genre group 1106 of song clips further into subgroups of song clips that are boosted 1108, 1112 and normal song clips 1110, 1114 that are not boosted. For example the liked genre group 1104 may be split into a boosted clips group 1108 and a normal (i.e., non-boosted) clips group 1110, and the other genre group 1106 may be split into a boosted clips group 1112 and a normal (i.e., non-boosted) clips group 1114. In some embodiments, boosted song clips may be song clips that the matching application may be promoting or otherwise weighting more heavily than normal clips for some reason. For example, in some embodiments, the artist may have paid or provided some other incentive for the matching application to boost one, some, or all of that artist's clips. In some embodiments, the boosted song clips may be those that the matching application has determined to be particularly of interested to the user based on specific user selections or prior user behavior making song clip preferences. In some embodiments, the matching system may store the boosted clips in a particular boosted database, or otherwise include markers on the stored boosted clips indicating that the clip has been given “boosted” status. Other reasons for boosting certain song clips may also be used consistent with the scope of the disclosure.

In some embodiments, at 1107, the matching application may also sort the song clips into additional subgroups based on quality. In some embodiments, song quality may be a measure of the digital sound quality associated with the particular music file uploaded by the artist or otherwise available to the matching application. For example, certain song clips may have a higher or lower bitrate that may correspond with higher or lower sound quality. In some embodiments, the song clip quality may be measured based on other ratings and preferences determined from other user of the matching application. For example, song clips that have a higher ratio of likes indicated by more users may be sorted as higher quality than those with a lower ratio of likes or other form of preference shown by users of the matching application. In some embodiments, other measures of song clip quality may be used, such as popularity of a song on other music platforms or the number of song clips that a particular artist may have available and/or the overall popularity of that artist's songs. Accordingly, at 1107, each of the boosted song clips groups 1108, 1112 and each of the normal clips groups 1110, 1114 may be sorted into high/low ratio groups 1116, 1118, 1120, 1122. In some embodiments, based on sorting by quality at 1107, a unique artist 1124 may be selected, such as amongst Artists A-H. In some embodiments, the matching application may sort the song clips into additional subgroups base on unique artists 1124, and then by song clips associated with each respective unique artist. Each artist A-H may include one or more song clips 1126 associated with the a particular artist that may be ordered in a queue. The queue of song clips 1126 for each artist 1124 may be determined in various ways, such as by artist preference as indicated via the matching application in the artist's profile, based on user preferences and observed activity (e.g., likes of similar songs by that artist or other artists), etc.

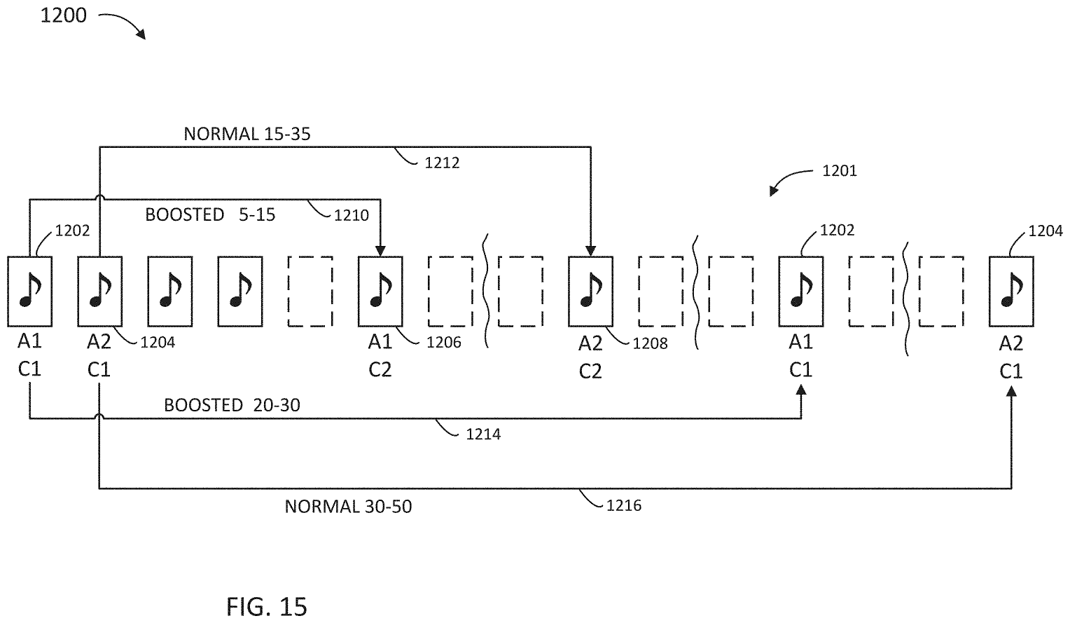

The music application may then make as song clip recommendation 1140 based on this logic. For example, in some embodiments, the matching application may make a recommendation by first narrowing down the song clips 1102 by liked genres for the user 1103, then by boosted song clips 1105, then by higher song clip quality 1107, then by artist 1109, and then song 1111. In such embodiments the recommended song clip may be a song clip that is in a liked musical genre, may be boosted, and may have high song clip quality. Accordingly, in some embodiments, based on the recommendation logic 1100, the matching application may present recommended clips 1140 to the user in order of Artist A through Artist H. For example, a song clip from Artist A, which was of a liked genre 1104, was from the boosted clips group 1108, had a high ratio at 116, and was the first song clip 1126 in the artist queue may be shown to the user first. Similarly, a song clip from Artist B, which was of a liked genre 1104, was from the boosted clips group 1108, but was of a low ratio 1116, and was first in Artist B's clip queue may be shown second. Similar logic may follow for recommended song clips 1140 for Artists C-H. In some embodiments, the queue of clips shown to a user may be updated regularly based on user likes or other inputs, such as indicated below with respect to FIG. 15.

FIG. 15 shows an embodiment of how the matching application may space apart song clip recommendations using a clip shuffling logic 1200, particularly related to normal (non-boosted) artists versus boosted artists or song clips. For example, in some embodiments, a song clips from a boosted artist may reappear on a user's recommended song clips more frequently than a song clips from a normal, non-boosted artist. In the non-limiting embodiment illustrated in FIG. 15, Artist 1 (A1) may be a boosted artist or song Clip 1 (C1) by Artist 1 (clip A1C1) may be a boosted song clip. Accordingly, the clip shuffling logic 1200 may including repeating A1 song clips more frequently, such as once after about 5-15 other song clips 1120, than a normal artist song clip, which may be repeated once after about 15-35 song clips 1212. Similarly, song clips from a boosted artist may be repeated a second time after about 20-30 other song clips 1214, while a song clips from a normal (non-boosted) artist or non-boosted song clips may be repeated a second time after about 30-50 other song clips 1216. Specifically, in FIG. 15, Artist 1 (A1) may be a boosted artist and Artist 2 (A2) may be a non-boosted artist. Song clip A1C1 1202 may be first in a clip queue 1201, and song clip A2C1 1204 may be second in the clip queue. Because Artist A1 is a boosted artist (or clip A1C1 is a boosted song clip), a second song clip A1C2 1206 may be queued 5-15 slots after song clip A1C1 1202, while a second song clip A2C2 1208 may be queued 15-35 slots after song clip A2C1 1204. Continuing the example in FIG. 15, a song clip A1C1 1202 by a boosted artist may be repeated in the clip queue more quickly than a song clip A2C1 1204 by a normal (non-boosted) artist or clip. For example, the boosted artist A1 may have the same song clip A1C1 1202 repeated after 20-30 clips 1214, while the normal artist A2 may have the same song clip A2C1 1204 repeated only after 30-50 clips 1216. In this way, in some embodiments, boosted songs or songs by boosted artists may be recommended to a user more frequently than normal, non-boosted song clips or song clips by non-boosted artists, which may result in more users liking the boosted song clips and becoming more familiar with them. Of course, those skilled in the art will recognize that the numbers of song clips prior to first and second repeats of a boosted or non-boosted song clip are not limiting and may have various ranges consistent with the scope of the disclosure. In other words, those skilled in the art will understand that boosted slots 5-15 and normal slots 15-35 are merely exemplary slot spacing, and that other spacing consistent with the beneficial treatment of boosted artists/clips over normal (non-boosted) clips are contemplated herein.

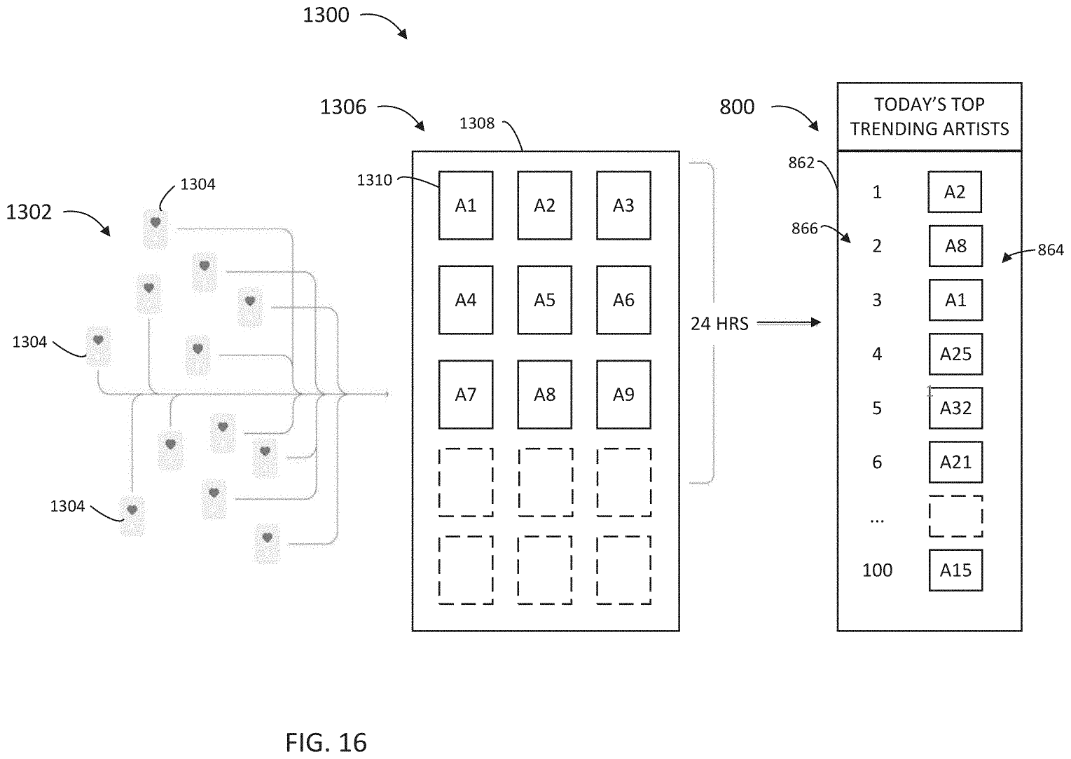

FIG. 16 is a diagram illustrating an embodiment of a method 1300 for constructing a top trending artists list 864 that may be displayed on a top trending artists screen 862 of the GUI 800 matching application. The logic flow of constructing the top trending artist list may include the matching system receiving user preferences, at 1302, from multiple users from their respective computing devices 1304 as they review song clips, accumulating and aggregating those user preferences at 1306, and creating a real-time top trending artist list 864 based on the aggregated likes and other preference data accumulated for a prior predetermined time period, such as 24 hours. For example, in some embodiments, the matching application may be running on the computing devices 1304 of a plurality of users, each of which may be reviewing song clips and indicating likes or dislikes by swiping left or right, or using another suitable preference indicator. Those use preferences may be received by the matching system, such as by the matching server 80 described with respect to FIG. 1. The matching server 80 or other suitable computer node may keep a tally of the total number of likes attributable to song clips attributable to each artist and/or to particular song clips. In some embodiments, the system may aggregate, such as in a trending artist database 1308, the total likes based on artist 1310, and rank the artists in a particular order, such as from most likes to least likes. In some embodiments, the trending artist database 1308 may include only artists within a predetermined top number of artists, such as top 40, top 100, etc. In some embodiments, the matching system may then create a substantially real-time top trending artists chart 864 that may be displayed to a user via the GUI 800. In some embodiments, the accumulated likes may be tallied based on a predetermined set time period, such as number of likes received in the previous 24 hours, or 48 hours, or week, or month, or year, etc. In some embodiments, the matching system may update the top trending artists list in substantially real-time based on the current number of accumulated likes. In some embodiments, the list may be updated once per second, or once per 5 seconds, or once per 10 seconds, or once per minute, etc. In some embodiments, the top trending artist list 864 may be updated based on each new like that may be received by the matching system. The result, in some embodiments, may be the matching application displaying, on each user computing device running the matching application, a dynamic top trending artist chart 864 that may constantly update based on ongoing user preference indications as determined through the matching application.

FIG. 16 includes an embodiment of a screen shot of a top trending artists screen 862 that may be used in some embodiments of the GUI 800 of the matching application. In some embodiments, the top trending artists screen 862 may display a list of the top artists based on user “swipes” that may be updated in substantially real time. In other words, as users swipe left or right to indicate their artist preferences, the top trending artists screen 862 may dynamically display updated rankings 866 for trending artists. It should be appreciated that, in some embodiments, virtually any number of trending artists may be used, such as top 5, 10, 25, 40, 50, 100, etc. In some embodiments, the top trending artists screen 862 may be accessed in the matching application via an icon, button, or other command.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method for matching users to artists, the method comprising:
receiving one or more audio files from an artist computing device;
receiving a selection of a first song clip from the artist computing device, wherein the first song clip is a portion of a first audio file of the one or more audio files and is associated with a first artist;
receiving a visual content file associated with the first song clip from the artist computing device;
storing the first song clip in a song clip database including a plurality of song clips associated with a plurality of artists;
causing the first song clip to be played on a user computing device associated with a user, wherein the first song clip is played via a user interface (UI);
receiving a like indication from the user via the UI while the first song clip is playing; and
determining a song queue based at least partially on receiving the like indication from the user, wherein the song queue includes one or more of the plurality of song clips.

2. The method of claim 1 further comprising:
causing additional song clips associated with the first artist to be played on the user device;
receiving one or more additional like indications from the user via the UI while the additional song clips are playing;
determining whether a number of like indications associated with the first artist has exceeded a threshold; and
providing a match indication via the UI when the number of like indications associated with the first artist has exceeded the threshold.

3. The method of claim 1 further comprising displaying visual content included in the visual content file associated with the first song clip via the UI while the first song clip is playing on the user computing device.

4. The method of claim 1 further comprising, in response to receiving the selection of the first song clip and the visual content file from the artist computing device:
causing a preview of a media clip of the first song and the visual content to play on the artist computing device; and
receiving an approval input from the artist computing device indicating that the artist approves of the media clip.

5. The method of claim 1 further comprising:
based on receiving the like indication, determining whether a super like has been indicated;
based on the determination that a super like has been indicated, determine whether a user profile associated with the user includes at least one super like; and
providing a match indication via the UI when the user profile includes at least one super like.

6. The method of claim 1 further comprising providing an instant match availability indication via the UI while the first song clip is playing.

7. The method of claim 6 further comprising:
receiving an instant match input via the UI from the user computing device; and
providing a match indication via the UI based on receiving the instant match input.

8. The method of claim 1 further comprising displaying on the user computing device, via the UI, a matches screen showing one or more matched artists, wherein the one or more matched artists are artists for which the user has received at least one match indication.

9. The method of claim 1 further comprising:
receiving a plurality of like indication from a plurality of users, the plurality of like indications each associated with one of the plurality of artists having song clips in the song clip database;
aggregating the like indications received for each artist of the plurality of artists; and
ranking the plurality of artists based on a total number of like indications received during a predetermined time period.

10. The method of claim 9 further comprising displaying a ranked list of at least a subset of the plurality of artists via the UI.

11. The method of claim 9 wherein the predetermined time period is twenty-four hours.

12. A computer-implemented method of matching artists to users, the method comprising:
receiving at least one song clip associated with each of a plurality of artists via an artist computing device associated with each of the plurality of artists;
aggregating the plurality of song clips into a song clip database;
determining a song queue for a user based on one or more user preferences associated with the user, the song queue including a subset of the plurality of song clips in the song clip database;
causing the song queue to play on a user computing device associated with a user via a user interface (UI);
receiving a like indication from the user via the UI while at least one song clip from the song queue is playing; and
providing a match indication via the UI when a number of like indications associated with song clips associated with a particular artist has exceeded a threshold.

13. The method of claim 12 further comprising receiving a visual content file associated with one or more of the at least one song clips.

14. The method of claim 13 further comprising displaying visual content included in the visual content file via the UI while the one or more associated at least one song clips plays on the user computing device.

15. The method of claim 12 further comprising providing an instant match availability indication via the UI while each song clip of the song queue is playing.

16. The method of claim 15 further comprising:
receiving an instant match input via the UI from the user computing device; and
providing a match indication via the UI based on receiving the instant match input.

17. The method of claim 12, wherein the one or more use preferences includes one or more genres of song clips for which the user has previously provided a like indication.

18. The method of claim 12, wherein the song queue includes song clips associated with artists have in a boosted status and song clips associated that do not have the boosted status, and wherein song clips associated with artists having a boosted status are included in the song queue more frequently than song clips associated with the artists that do not have the boosted status.

19. A computer-implemented method of matching an artist to users, the method comprising:
receiving an audio file from a plurality of artist computing devices each associated with an artist;
receiving a selection of a song clip from each respective artist computing device of the plurality of artist computing devices, wherein each song clip is a portion of the audio file received from each respective artist computing device;
receiving a visual content file from each respective artist computing device of the plurality of artist computing devices, wherein each visual content file is associated with each respective song clip selected from the artist computing device;
aggregating the song clips and respective visual content files in a song clip database;
determining a song queue including a subset of the song clips in the song clip database;
causing the song queue to play on a user computing device associated with a user via a user interface (UI);
receiving one or more like indications from the user via the UI while the song clips are playing;
determining whether a number of like indications associated with a particular artist has exceeded a threshold; and
providing a match indication via the UI when the number of like indications associated with the particular artist has exceeded the threshold.

20. The method of claim 19, wherein the song queue is determined based on at least one of a genre associated with each song clip, a like history associated with the user, a boosted status of the artist associated with each sound clip, or a favorite genre indicated in a user profile associated with the user.
